(19) United States
(12) Patent Application Publication
(10) Pub. No.: US 2018/0201144 A1
(43) Pub. Date: Jul. 19, 2018

(54) AUTHENTICATION USING ELECTROMAGNET SIGNAL DETECTION

(71) Applicant: NextEV USA, Inc., San Jose, CA (US)

(72) Inventor: Austin L. Newman, San Jose, CA (US)

(21) Appl. No.: 15/405,955

(22) Filed: Jan. 13, 2017

(51) Int. Cl. B60L 11/18; B60P 3/12; B60K 1/02; B60K 35/00; B60R 1/00; B60L 7/10; B60D 1/18

(52) U.S. Cl. CPC B60L 11/1818; B60P 3/125; B60L 11/1877; B60K 1/02; B60L 11/1824; B60K 35/00; B60L 11/04; B60L 7/10; B60D 1/18; B60L 2230/12; B60L 11/1803; B60L 11/1805; B60L 11/182; B60R 1/00

(57) ABSTRACT

Systems of an electrical vehicle and the operations thereof are provided. In particular, a towing cable and methods for utilizing the same in a towing scenario are described. The towing cable is described to facilitate the transfer of power between vehicles as well as data between vehicles. The data transferred between the vehicles involved in the towing include sensor information of the towed vehicle as well as control signals.

### FIELD

The present disclosure is generally directed to vehicle systems, in particular, toward electric and/or hybrid-electric vehicles.

### BACKGROUND

In recent years, transportation methods have changed substantially. This change is due in part to a concern over the limited availability of natural resources, a proliferation in personal technology, and a societal shift to adopt more environmentally-friendly transportation solutions. These considerations have encouraged the development of a number of new flexible-fuel vehicles, hybrid-electric vehicles, and electric vehicles.

While these vehicles appear to be new they are generally implemented as a number of traditional subsystems that are merely tied to an alternative power source. In fact, the design and construction of the vehicles is limited to standard frame sizes, shapes, materials, and transportation concepts. Among other things, these limitations fail to take advantage of the benefits of new technology, power sources, and support infrastructure.

### BRIEF DESCRIPTION OF THE DRAWINGS

FIG. 1 shows a vehicle in accordance with embodiments of the present disclosure;

FIG. 2 shows a plan view of the vehicle in accordance with at least some embodiments of the present disclosure;

FIG. 3 shows a plan view of the vehicle in accordance with embodiments of the present disclosure

FIG. 4 shows an embodiment of the instrument panel of the vehicle according to one embodiment of the present disclosure;

FIG. 5 is a block diagram of an embodiment of an electrical system of the vehicle;

FIG. 6 is a block diagram of an embodiment of a power generation unit associated with the electrical system of the vehicle;

FIG. 7 is a block diagram depicting details of an energy conversion system;

FIG. 8 is a block diagram of an embodiment of loads associated with the electrical system of the vehicle;

FIG. 9A is a diagram depicting a towing vehicle and towed vehicle in accordance with embodiments of the present disclosure;

FIG. 9B is a block diagram depicting components of a towing vehicle and towed vehicle in accordance with embodiments of the present disclosure;

FIG. 10 is a diagram depicting a charging port of a vehicle in accordance with embodiments of the present disclosure;

FIG. 11 is a diagram depicting a towing cable in accordance with embodiments of the present disclosure;

FIG. 12A is a top view of a towing and towed vehicle in a first towing position in accordance with embodiments of the present disclosure;

FIG. 12B is a top view of a towing and towed vehicle in a second towing position in accordance with embodiments of the present disclosure;

FIG. 12C is a top view of a towing and towed vehicle in a third towing position in accordance with embodiments of the present disclosure;

FIG. 12D is a top view of a towing and towed vehicle in a fourth towing position in accordance with embodiments of the present disclosure;

FIG. 12E is a top view of a towing and towed vehicle in a fifth towing position in accordance with embodiments of the present disclosure;

FIG. 12F is a top view of a towing and towed vehicle in a sixth towing position in accordance with embodiments of the present disclosure;

FIG. 13 is a flow diagram depicting a towing method in accordance with embodiments of the present disclosure;

FIG. 14 is a flow diagram depicting a towing method from the perspective of a towed vehicle in accordance with embodiments of the present disclosure; and

FIG. 15 is a flow diagram depicting a towing method from the perspective of a towing vehicle in accordance with embodiments of the present disclosure.

### DETAILED DESCRIPTION

Embodiments of the present disclosure will be described in connection with a vehicle, and in some embodiments, an electric vehicle, rechargeable electric vehicle, and/or hybrid-electric vehicle and associated systems.

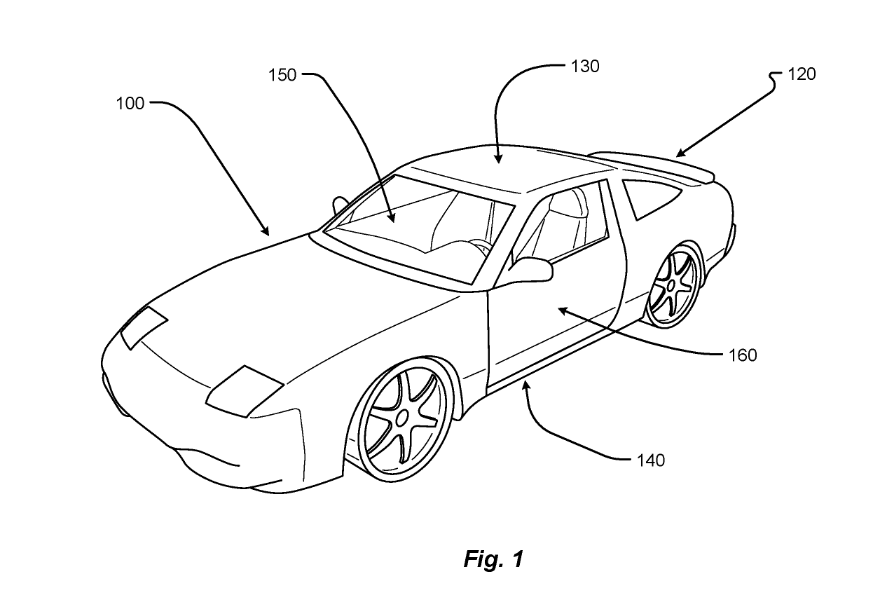

FIG. 1 shows a perspective view of a vehicle 100 in accordance with embodiments of the present disclosure. The electric vehicle 100 comprises a vehicle front 110, vehicle aft 120, vehicle roof 130, at least one vehicle side 160, a vehicle undercarriage 140, and a vehicle interior 150. In any event, the vehicle 100 may include a frame 104 and one or more body panels 108 mounted or affixed thereto. The vehicle 100 may include one or more interior components (e.g., components inside an interior space 150, or user space, of a vehicle 100, etc.), exterior components (e.g., components outside of the interior space 150, or user space, of a vehicle 100, etc.), drive systems, controls systems, structural components, etc.

Although shown in the form of a car, it should be appreciated that the vehicle 100 described herein may include any conveyance or model of a conveyance, where the conveyance was designed for the purpose of moving one or more tangible objects, such as people, animals, cargo, and the like. The term “vehicle” does not require that a conveyance moves or is capable of movement. Typical vehicles may include but are in no way limited to cars, trucks, motorcycles, busses, automobiles, trains, railed conveyances, boats, ships, marine conveyances, submarine conveyances, airplanes, space craft, flying machines, human-powered conveyances, and the like.

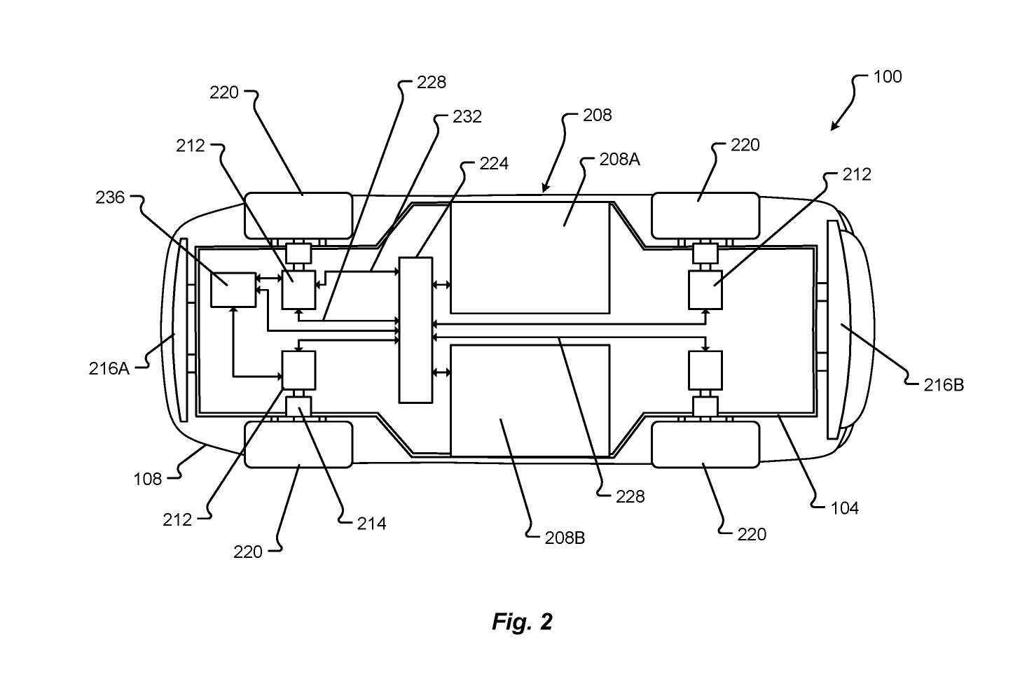

Referring now to FIG. 2, a plan view of a vehicle 100 will be described in accordance with embodiments of the present disclosure. As provided above, the vehicle 100 may comprise a number of electrical and/or mechanical systems, subsystems, etc. The mechanical systems of the vehicle 100 can include structural, power, safety, and communications subsystems, to name a few. While each subsystem may be described separately, it should be appreciated that the components of a particular subsystem may be shared between one or more other subsystems of the vehicle 100.

The structural subsystem includes the frame 104 of the vehicle 100. The frame 104 may comprise a separate frame and body construction (i.e., body-on-frame construction), a unitary frame and body construction (i.e., a unibody construction), or any other construction defining the structure of the vehicle 100. The frame 104 may be made from one or more materials including, but in no way limited to steel, titanium, aluminum, carbon fiber, plastic, polymers, etc., and/or combinations thereof. In some embodiments, the frame 104 may be formed, welded, fused, fastened, pressed, etc., combinations thereof, or otherwise shaped to define a physical structure and strength of the vehicle 100. In any event, the frame 104 may comprise one or more surfaces, connections, protrusions, cavities, mounting points, tabs, slots, or other features that are configured to receive other components that make up the vehicle 100. For example, the body panels 108, powertrain subsystem, controls systems, interior components, communications subsystem, and safety subsystem may interconnect with, or attach to, the frame 104 of the vehicle 100.

The frame 104 may include one or more modular system and/or subsystem connection mechanisms. These mechanisms may include features that are configured to provide a selectively interchangeable interface for one or more of the systems and/or subsystems described herein. The mechanisms may provide for a quick exchange, or swapping, of components while providing enhanced security and adaptability over conventional manufacturing or attachment. For instance, the ability to selectively interchange systems and/or subsystems in the vehicle 100 allow the vehicle 100 to adapt to the ever-changing technological demands of society and advances in safety. Among other things, the mechanisms may provide for the quick exchange of batteries, capacitors, power sources 208A, 208B, motors 212, engines, safety equipment, controllers, user interfaces, interiors exterior components, body panels 108, bumpers 216, sensors, etc., and/or combinations thereof. Additionally or alternatively, the mechanisms may provide unique security hardware and/or software embedded therein that, among other things, can prevent fraudulent or low quality construction replacements from being used in the vehicle 100. Similarly, the mechanisms, subsystems, and/or receiving features in the vehicle 100 may employ poka-yoke, or mistake-proofing, features that ensure a particular mechanism is always interconnected with the vehicle 100 in a correct position, function, etc.

By way of example, complete systems or subsystems may be removed and/or replaced from a vehicle 100 utilizing a single-minute exchange (“SME”) principle. In some embodiments, the frame 104 may include slides, receptacles, cavities, protrusions, and/or a number of other features that allow for quick exchange of system components. In one embodiment, the frame 104 may include tray or ledge features, mechanical interconnection features, locking mechanisms, retaining mechanisms, etc., and/or combinations thereof. In some embodiments, it may be beneficial to quickly remove a used power source 208A, 208B (e.g., battery unit, capacitor unit, etc.) from the vehicle 100 and replace the used power source 208A, 208B with a charged or new power source. Continuing this example, the power source 208A, 208B may include selectively interchangeable features that interconnect with the frame 104 or other portion of the vehicle 100.

The power system of the vehicle 100 may include the powertrain, power distribution system, accessory power system, and/or any other components that store power, provide power, convert power, and/or distribute power to one or more portions of the vehicle 100. The powertrain may include the one or more electric motors 212 of the vehicle 100. The electric motors 212 are configured to convert electrical energy provided by a power source into mechanical energy. This mechanical energy may be in the form of a rotational or other output force that is configured to propel or otherwise provide a motive force for the vehicle 100.

In some embodiments, the vehicle 100 may include one or more drive wheels 220 that are driven by the one or more electric motors 212 and motor controllers 214. In some cases, the vehicle 100 may include an electric motor 212 configured to provide a driving force for each drive wheel 220. In other cases, a single electric motor 212 may be configured to share an output force between two or more drive wheels 220 via one or more power transmission components. It is an aspect of the present disclosure that the powertrain may include one or more power transmission components, motor controllers 214, and/or power controllers that can provide a controlled output of power to one or more of the drive wheels 220 of the vehicle 100. The power transmission components, power controllers, or motor controllers 214 may be controlled by at least one other vehicle controller or computer system as described herein.

As provided above, the powertrain of the vehicle 100 may include one or more power sources 208A, 208B. These one or more power sources 208A, 208B may be configured to provide drive power, system and/or subsystem power, accessory power, etc. While described herein as a single power source 208 for sake of clarity, embodiments of the present disclosure are not so limited. For example, it should be appreciated that independent, different, or separate power sources 208A, 208B may provide power to various systems of the vehicle 100. For instance, a drive power source may be configured to provide the power for the one or more electric motors 212 of the vehicle 100, while a system power source may be configured to provide the power for one or more other systems and/or subsystems of the vehicle 100. Other power sources may include an accessory power source, a backup power source, a critical system power source, and/or other separate power sources. Separating the power sources 208A, 208B in this manner may provide a number of benefits over conventional vehicle systems. For example, separating the power sources 208A, 208B allow one power source 208 to be removed and/or replaced independently without requiring that power be removed from all systems and/or subsystems of the vehicle 100 during a power source 208 removal/replacement. For instance, one or more of the accessories, communications, safety equipment, and/or backup power systems, etc., may be maintained even when a particular power source 208A, 208B is depleted, removed, or becomes otherwise inoperable.

In some embodiments, the drive power source may be separated into two or more cells, units, sources, and/or systems. By way of example, a vehicle 100 may include a first drive power source 208A and a second drive power source 208B. The first drive power source 208A may be operated independently from or in conjunction with the second drive power source 208B and vice versa. Continuing this example, the first drive power source 208A may be removed from a vehicle while a second drive power source 208B can be maintained in the vehicle 100 to provide drive power. This approach allows the vehicle 100 to significantly reduce weight (e.g., of the first drive power source 208A, etc.) and improve power consumption, even if only for a temporary period of time. In some cases, a vehicle 100 running low on power may automatically determine that pulling over to a rest area, emergency lane, and removing, or “dropping off,” at least one power source 208A, 208B may reduce enough weight of the vehicle 100 to allow the vehicle 100 to navigate to the closest power source replacement and/or charging area. In some embodiments, the removed, or “dropped off,” power source 208A may be collected by a collection service, vehicle mechanic, tow truck, or even another vehicle or individual.

The power source 208 may include a GPS or other geographical location system that may be configured to emit a location signal to one or more receiving entities. For instance, the signal may be broadcast or targeted to a specific receiving party. Additionally or alternatively, the power source 208 may include a unique identifier that may be used to associate the power source 208 with a particular vehicle 100 or vehicle user. This unique identifier may allow an efficient recovery of the power source 208 dropped off. In some embodiments, the unique identifier may provide information for the particular vehicle 100 or vehicle user to be billed or charged with a cost of recovery for the power source 208.

The power source 208 may include a charge controller 224 that may be configured to determine charge levels of the power source 208, control a rate at which charge is drawn from the power source 208, control a rate at which charge is added to the power source 208, and/or monitor a health of the power source 208 (e.g., one or more cells, portions, etc.). In some embodiments, the charge controller 224 or the power source 208 may include a communication interface. The communication interface can allow the charge controller 224 to report a state of the power source 208 to one or more other controllers of the vehicle 100 or even communicate with a communication device separate and/or apart from the vehicle 100. Additionally or alternatively, the communication interface may be configured to receive instructions (e.g., control instructions, charge instructions, communication instructions, etc.) from one or more other controllers or computers of the vehicle 100 or a communication device that is separate and/or apart from the vehicle 100.

The powertrain includes one or more power distribution systems configured to transmit power from the power source 208 to one or more electric motors 212 in the vehicle 100. The power distribution system may include electrical interconnections 228 in the form of cables, wires, traces, wireless power transmission systems, etc., and/or combinations thereof. It is an aspect of the present disclosure that the vehicle 100 include one or more redundant electrical interconnections 232 of the power distribution system. The redundant electrical interconnections 232 can allow power to be distributed to one or more systems and/or subsystems of the vehicle 100 even in the event of a failure of an electrical interconnection portion of the vehicle 100 (e.g., due to an accident, mishap, tampering, or other harm to a particular electrical interconnection, etc.). In some embodiments, a user of a vehicle 100 may be alerted via a user interface associated with the vehicle 100 that a redundant electrical interconnection 232 is being used and/or damage has occurred to a particular area of the vehicle electrical system. In any event, the one or more redundant electrical interconnections 232 may be configured along completely different routes than the electrical interconnections 228 and/or include different modes of failure than the electrical interconnections 228 to, among other things, prevent a total interruption power distribution in the event of a failure.

In some embodiments, the power distribution system may include an energy recovery system 236. This energy recovery system 236, or kinetic energy recovery system, may be configured to recover energy produced by the movement of a vehicle 100. The recovered energy may be stored as electrical and/or mechanical energy. For instance, as a vehicle 100 travels or moves, a certain amount of energy is required to accelerate, maintain a speed, stop, or slow the vehicle 100. In any event, a moving vehicle has a certain amount of kinetic energy. When brakes are applied in a typical moving vehicle, most of the kinetic energy of the vehicle is lost as the generation of heat in the braking mechanism. In an energy recovery system 236, when a vehicle 100 brakes, at least a portion of the kinetic energy is converted into electrical and/or mechanical energy for storage. Mechanical energy may be stored as mechanical movement (e.g., in a flywheel, etc.) and electrical energy may be stored in batteries, capacitors, and/or some other electrical storage system. In some embodiments, electrical energy recovered may be stored in the power source 208. For example, the recovered electrical energy may be used to charge the power source 208 of the vehicle 100.

The vehicle 100 may include one or more safety systems. Vehicle safety systems can include a variety of mechanical and/or electrical components including, but in no way limited to, low impact or energy-absorbing bumpers 216A, 216B, crumple zones, reinforced body panels, reinforced frame components, impact bars, power source containment zones, safety glass, seatbelts, supplemental restraint systems, air bags, escape hatches, removable access panels, impact sensors, accelerometers, vision systems, radar systems, etc., and/or the like. In some embodiments, the one or more of the safety components may include a safety sensor or group of safety sensors associated with the one or more of the safety components. For example, a crumple zone may include one or more strain gages, impact sensors, pressure transducers, etc. These sensors may be configured to detect or determine whether a portion of the vehicle 100 has been subjected to a particular force, deformation, or other impact. Once detected, the information collected by the sensors may be transmitted or sent to one or more of a controller of the vehicle 100 (e.g., a safety controller, vehicle controller, etc.) or a communication device associated with the vehicle 100 (e.g., across a communication network, etc.).

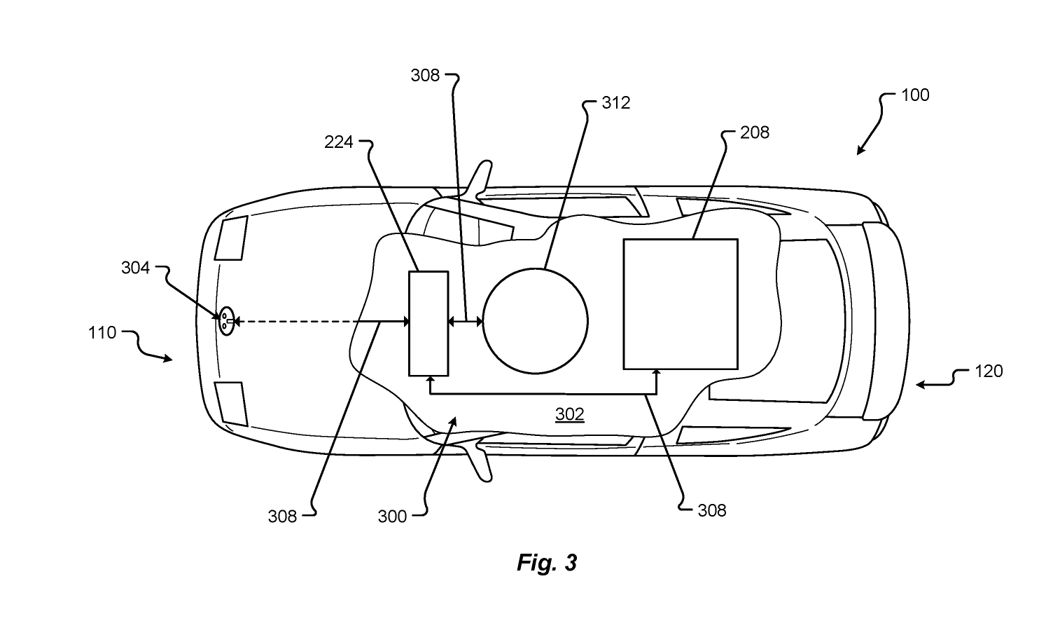

FIG. 3 shows a plan view of the vehicle 100 in accordance with embodiments of the present disclosure. In particular, FIG. 3 shows a broken section 302 of a charging system 300 for the vehicle 100. The charging system 300 may include a plug or receptacle 304 configured to receive power from an external power source (e.g., a source of power that is external to and/or separate from the vehicle 100, etc.). An example of an external power source may include the standard industrial, commercial, or residential power that is provided across power lines. Another example of an external power source may include a proprietary power system configured to provide power to the vehicle 100. In any event, power received at the plug/receptacle 304 may be transferred via at least one power transmission interconnection 308. Similar, if not identical, to the electrical interconnections 228 described above, the at least one power transmission interconnection 308 may be one or more cables, wires, traces, wireless power transmission systems, etc., and/or combinations thereof. Electrical energy in the form of charge can be transferred from the external power source to the charge controller 224. As provided above, the charge controller 224 may regulate the addition of charge to at least one power source 208 of the vehicle 100 (e.g., until the at least one power source 208 is full or at a capacity, etc.).

In some embodiments, the vehicle 100 may include an inductive charging system and inductive charger 312. The inductive charger 312 may be configured to receive electrical energy from an inductive power source external to the vehicle 100. In one embodiment, when the vehicle 100 and/or the inductive charger 312 is positioned over an inductive power source external to the vehicle 100, electrical energy can be transferred from the inductive power source to the vehicle 100. For example, the inductive charger 312 may receive the charge and transfer the charge via at least one power transmission interconnection 308 to the charge controller 324 and/or the power source 208 of the vehicle 100. The inductive charger 312 may be concealed in a portion of the vehicle 100 (e.g., at least partially protected by the frame 104, one or more body panels 108, a shroud, a shield, a protective cover, etc., and/or combinations thereof) and/or may be deployed from the vehicle 100. In some embodiments, the inductive charger 312 may be configured to receive charge only when the inductive charger 312 is deployed from the vehicle 100. In other embodiments, the inductive charger 312 may be configured to receive charge while concealed in the portion of the vehicle 100.

In addition to the mechanical components described herein, the vehicle 100 may include a number of user interface devices. The user interface devices receive and translate human input into a mechanical movement or electrical signal or stimulus. The human input may be one or more of motion (e.g., body movement, body part movement, in two-dimensional or three-dimensional space, etc.), voice, touch, and/or physical interaction with the components of the vehicle 100. In some embodiments, the human input may be configured to control one or more functions of the vehicle 100 and/or systems of the vehicle 100 described herein. User interfaces may include, but are in no way limited to, at least one graphical user interface of a display device, steering wheel or mechanism, transmission lever or button (e.g., including park, neutral, reverse, and/or drive positions, etc.), throttle control pedal or mechanism, brake control pedal or mechanism, power control switch, communications equipment, etc.

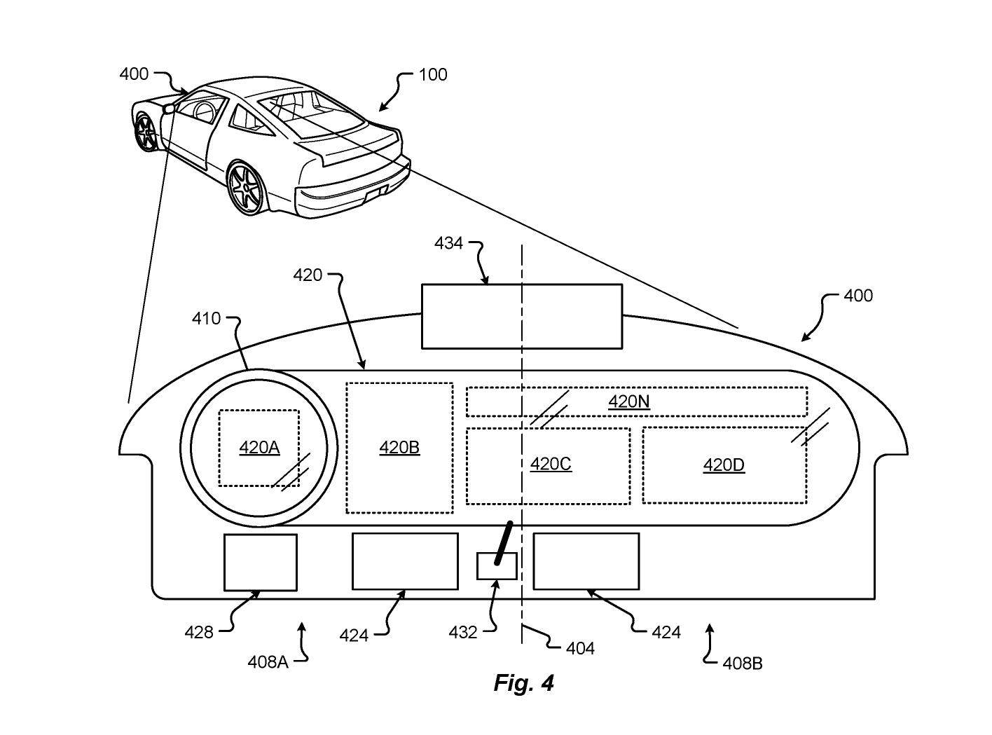

FIG. 4 shows one embodiment of the instrument panel 400 of the vehicle 100. The instrument panel 400 of vehicle 100 comprises a steering wheel 410, a vehicle operational display 420 (e.g., configured to present and/or display driving data such as speed, measured air resistance, vehicle information, entertainment information, etc.), one or more auxiliary displays 424 (e.g., configured to present and/or display information segregated from the operational display 420, entertainment applications, movies, music, etc.), a heads-up display 434 (e.g., configured to display any information previously described including, but in no way limited to, guidance information such as route to destination, or obstacle warning information to warn of a potential collision, or some or all primary vehicle operational data such as speed, resistance, etc.), a power management display 428 (e.g., configured to display data corresponding to electric power levels of vehicle 100, reserve power, charging status, etc.), and an input device 432 (e.g., a controller, touchscreen, or other interface device configured to interface with one or more displays in the instrument panel or components of the vehicle 100. The input device 432 may be configured as a joystick, mouse, touchpad, tablet, 3D gesture capture device, etc.). In some embodiments, the input device 432 may be used to manually maneuver a portion of the vehicle 100 into a charging position (e.g., moving a charging plate to a desired separation distance, etc.).

While one or more of displays of instrument panel 400 may be touch-screen displays, it should be appreciated that the vehicle operational display may be a display incapable of receiving touch input. For instance, the operational display 420 that spans across an interior space centerline 404 and across both a first zone 408A and a second zone 408B may be isolated from receiving input from touch, especially from a passenger. In some cases, a display that provides vehicle operation or critical systems information and interface may be restricted from receiving touch input and/or be configured as a non-touch display. This type of configuration can prevent dangerous mistakes in providing touch input where such input may cause an accident or unwanted control.

In some embodiments, one or more displays of the instrument panel 400 may be mobile devices and/or applications residing on a mobile device such as a smart phone. Additionally or alternatively, any of the information described herein may be presented to one or more portions 420A-N of the operational display 420 or other display 424, 428, 434. In one embodiment, one or more displays of the instrument panel 400 may be physically separated or detached from the instrument panel 400. In some cases, a detachable display may remain tethered to the instrument panel.

The portions 420A-N of the operational display 420 may be dynamically reconfigured and/or resized to suit any display of information as described. Additionally or alternatively, the number of portions 420A-N used to visually present information via the operational display 420 may be dynamically increased or decreased as required, and are not limited to the configurations shown.

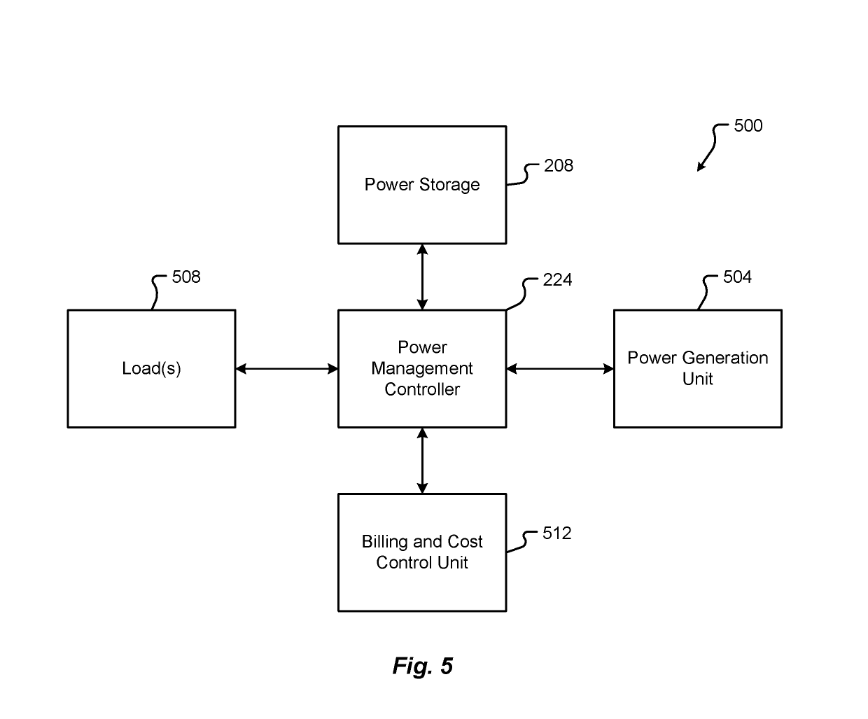

An embodiment of the electrical system 500 associated with the vehicle 100 may be as shown in FIG. 5. The electrical system 500 can include power source(s) that generate power, power storage that stores power, and/or load(s) that consume power. Power sources may be associated with a power generation unit 504. Power storage may be associated with a power storage system 208. Loads may be associated with loads 508. The electrical system 500 may be managed by a power management controller 224. Further, the electrical system 500 can include one or more other interfaces or controllers, which can include the billing and cost control unit 512.

The billing and cost control unit 512 may interface with the power management controller 224 to determine the amount of charge or power provided to the power storage 208 through the power generation unit 504. The billing and cost control unit 512 can then provide information for billing the vehicle owner. Thus, the billing and cost control unit 512 can receive and/or send power information to third party system(s) regarding the received charge from an external source. The information provided can help determine an amount of money required, from the owner of the vehicle, as payment for the provided power. Alternatively, or in addition, if the owner of the vehicle provided power to another vehicle (or another device/system), that owner may be owed compensation for the provided power or energy, e.g., a credit.

The power management controller 224 can be a computer or computing system(s) and/or electrical system with associated components, as described herein, capable of managing the power generation unit 504 to receive power, routing the power to the power storage 208, and then providing the power from either the power generation unit 504 and/or the power storage 208 to the loads 508. Thus, the power management controller 224 may execute programming that controls switches, devices, components, etc. involved in the reception, storage, and provision of the power in the electrical system 500.

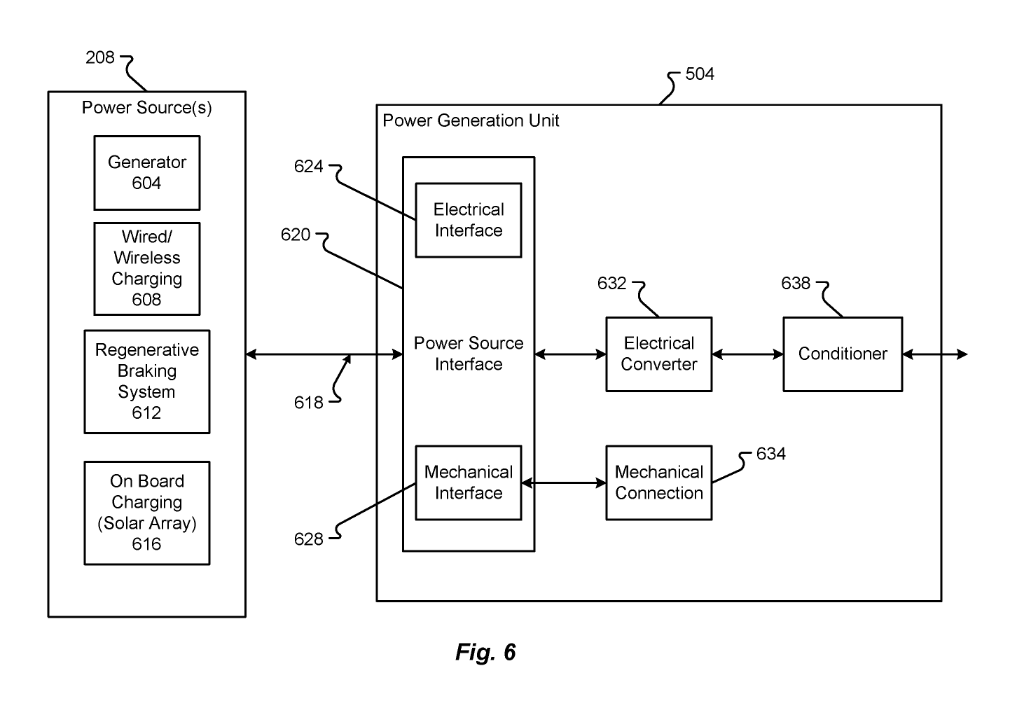

An embodiment of the power generation unit 504 may be as shown in FIG. 6. Generally, the power generation unit 504 may be electrically coupled to one or more power sources 208. The power sources 208 can include power sources internal and/or associated with the vehicle 100 and/or power sources external to the vehicle 100 to which the vehicle 100 electrically connects. One of the internal power sources can include an on board generator 604. The generator 604 may be an alternating current (AC) generator, a direct current (DC) generator or a self-excited generator. The AC generators can include induction generators, linear electric generators, and/or other types of generators. The DC generators can include homopolar generators and/or other types of generators. The generator 604 can be brushless or include brush contacts and generate the electric field with permanent magnets or through induction. The generator 604 may be mechanically coupled to a source of kinetic energy, such as an axle or some other power take-off. The generator 604 may also have another mechanical coupling to an exterior source of kinetic energy, for example, a wind turbine.

Another power source 208 may include wired or wireless charging 608. The wireless charging system 608 may include inductive and/or resonant frequency inductive charging systems that can include coils, frequency generators, controllers, etc. Wired charging may be any kind of grid-connected charging that has a physical connection, although, the wireless charging may be grid connected through a wireless interface. The wired charging system can include connectors, wired interconnections, the controllers, etc. The wired and wireless charging systems 608 can provide power to the power generation unit 504 from external power sources 208.

Internal sources for power may include a regenerative braking system 612. The regenerative braking system 612 can convert the kinetic energy of the moving car into electrical energy through a generation system mounted within the wheels, axle, and/or braking system of the vehicle 100. The regenerative braking system 612 can include any coils, magnets, electrical interconnections, converters, controllers, etc. required to convert the kinetic energy into electrical energy.

Another source of power 208, internal to or associated with the vehicle 100, may be a solar array 616. The solar array 616 may include any system or device of one or more solar cells mounted on the exterior of the vehicle 100 or integrated within the body panels of the vehicle 100 that provides or converts solar energy into electrical energy to provide to the power generation unit 504.

The power sources 208 may be connected to the power generation unit 504 through an electrical interconnection 618. The electrical interconnection 618 can include any wire, interface, bus, etc. between the one or more power sources 208 and the power generation unit 504.

The power generation unit 504 can also include a power source interface 620. The power source interface 620 can be any type of physical and/or electrical interface used to receive the electrical energy from the one or more power sources 208; thus, the power source interface 620 can include an electrical interface 624 that receives the electrical energy and a mechanical interface 628 which may include wires, connectors, or other types of devices or physical connections. The mechanical interface 628 can also include a physical/mechanical connection 634 to the power generation unit 504.

The electrical energy from the power source 208 can be processed through the power source interface 620 to an electric converter 632. The electric converter 632 may convert the characteristics of the power from one of the power sources into a useable form that may be used either by the power storage 208 or one or more loads 508 within the vehicle 100. The electrical converter 632 may include any electronics or electrical devices and/or component that can change electrical characteristics, e.g., AC frequency, amplitude, phase, etc. associated with the electrical energy provided by the power source 208. The converted electrical energy may then be provided to an optional conditioner 638. The conditioner 638 may include any electronics or electrical devices and/or component that may further condition the converted electrical energy by removing harmonics, noise, etc. from the electrical energy to provide a more stable and effective form of power to the vehicle 100.

Additional details of an energy conversion system 700 that may be used as part of the power generation unit 504 will be described in accordance with at least some embodiments of the present disclosure. The system 700 may include a power switch 708, a power electronic converter 712, a motor 716, a mechanical load 720, and a controller 724. The power switch 708 may selectively enable power to be provided to the power electronic converter 712 from either a primary power source 704 or a secondary power source 728 consistent with control signaling received over control signal path 748 from the controller 724. The primary power source 704 may be similar or identical to one or more of the power sources 208 and may be located on the vehicle 100. In other words, the primary power source 704 may correspond to a power source of the vehicle 100. The secondary power source 728, on the other hand, may correspond to a power source from another vehicle. For instance, the secondary power source 728 may correspond to a power source of a vehicle that is connected to the vehicle 100 in the event that the primary power source 704 becomes depleted or otherwise incapable of providing sufficient power to the motor 716.

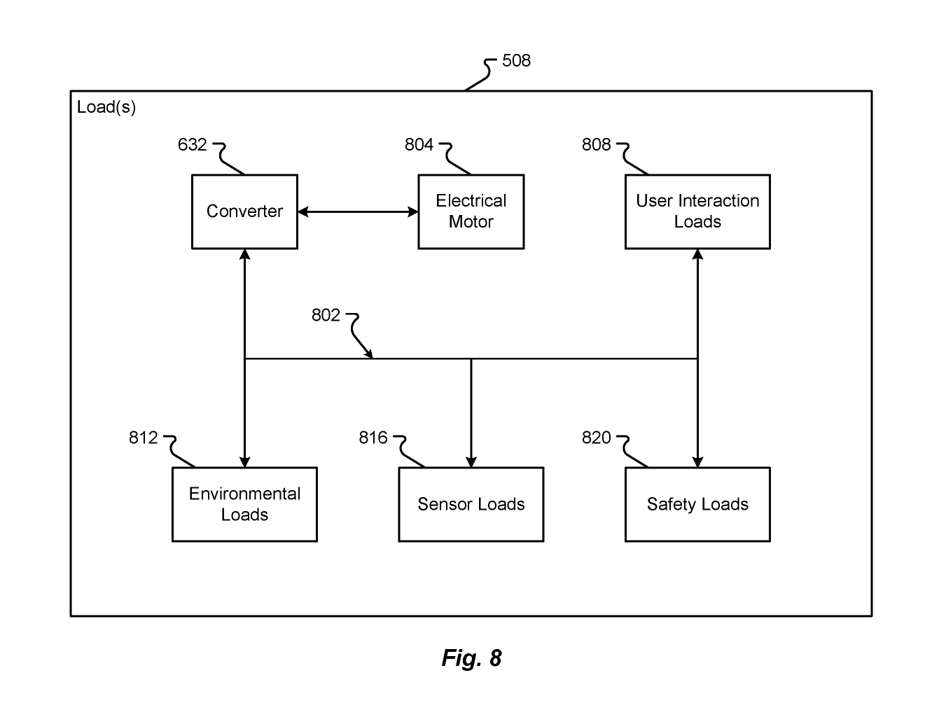

The power converter 712 may be similar or identical to converter 632. The motor 716 may be similar or identical to any one of the motors described herein (e.g., motor 212). The mechanical load 720 may be similar or identical to load 508 or any of the specific loads described with relation thereto in connection with FIG. 8.

The controller 724 may be positioned in a control feedback loop in which the controller 724 receives inputs 732, 736, 740 from both the motor 716 output 732 and from external sources 736, 740. The external control signals 736 received from the a primary control input may correspond to control signals generated within the vehicle 100 (e.g., signals which are used to navigate the vehicle 100 under normal operating conditions) may cause the controller 724 to control the motor 716 sufficient to provide power to the mechanical load 720. The other external input signal 740 received from a towing vehicle may correspond to control inputs used to control the vehicle from another vehicle during a towing scenario. Said another way, the external control input 740 from the towing vehicle may correspond to control signals that drive the motor 716, but that are received from a towing cable connecting the vehicle 100 with another vehicle. The external control inputs 736, 740 may be in the form of digital control signals, analog control signals, voltage control signals, current control signals, etc.

The motor feedback signal 732, on the other hand, may be provided to the controller 724 as a voltage signal, current signal, or the like. The motor feedback signal 732 may provide the controller 724 with current state and operational information for the motor 716. Based on the inputs 732, 736, 740 the controller 724 may determine how to further control the motor 716 with a motor control signal 744. The motor control signal 744 may be provided to the power electronic converter 712, which adjusts the amount of power/voltage/current provided to the motor 716 in response to the motor control signal 744. In some embodiments, the power converter 12 is configured to provide three-phase power to the motor 716, thereby enabling operation of the motor 716. In some embodiments, the motor 716 may be configured to be operated by single-phase power inputs or something other than a three-phase power input.

The controller 724 may also be configured to provide a switching control signal 748 to the power switch 708. The switching control signal 748 may cause the components of the power switch to connect the primary power source 704 to the power converter 712 or to connect the secondary power source 728 to the power converter 712. In some embodiments, only one of the power sources 704, 728 is allowed to be connected to the power converter 712 at a time. Thus, the switching control signal 748 may dictate which of the power sources 704, 728 is going to connect with the converter 712. As an example, the power switch 708 may comprise a number of FET devices that connect either the primary power source 704 or the secondary power source 728 to the power converter 712 (and therefore the motor 716) based upon the nature of the switching control signal 748. As a non-limiting example, the power switch 708 may only need to support two states of operation and the switching signal 748 may correspond to a binary control signal that, in one state, causes the primary power source 704 to connect with the power converter 712 and that, in the other state, causes the secondary power source 728 to connect to the power converter 712.A

Alternatively or additionally, the controller 724 can be used as a mechanism for motor control during driving of the vehicle 100. The controller 724 may be configured as a Field Programmable Gate Array (FPGA), an Application Specific Integrated Circuit (ASIC), or some other collection of hardware components. Alternatively or additionally, the controller 724 may comprise a microprocessor and internal memory that stores software instructions that are executable by the microprocessor. As mentioned above, the controller 724 may be responsive to external control signals 736, 740 that are provided by the vehicle user interface or more specifically the input device 432 of the control panel 400.

It should be appreciated that the energy conversion system 700 may be implemented for a single motor in the vehicle 100 (especially if the vehicle only comprises a single motor). Alternatively, if the vehicle 100 has multiple motors, one, some, or all of those multiple motors may be outfitted with and controlled by a controller 724. Further still, although the motor control signal 744 is shown as being provided to the power converter 712, it should be appreciated that the control signal could be provided to an intermediate device between the power switch 708 and power converter 712 or to some other device that is electrically coupled with the motor 716.

An embodiment of one or more loads 508 associated with the vehicle 100 may be as shown in FIG. 8. The loads 508 may include a bus or electrical interconnection system 802, which provides electrical energy to one or more different loads within the vehicle 100. The bus 802 can be any number of wires or interfaces used to connect the power generation unit 504 and/or power storage 208 to the one or more loads 508. The converter 632 may be an interface from the power generation unit 504 or the power storage 208 into the loads 508. The converter 632 may be the same or similar to electric converter 632 as shown in FIG. 6.

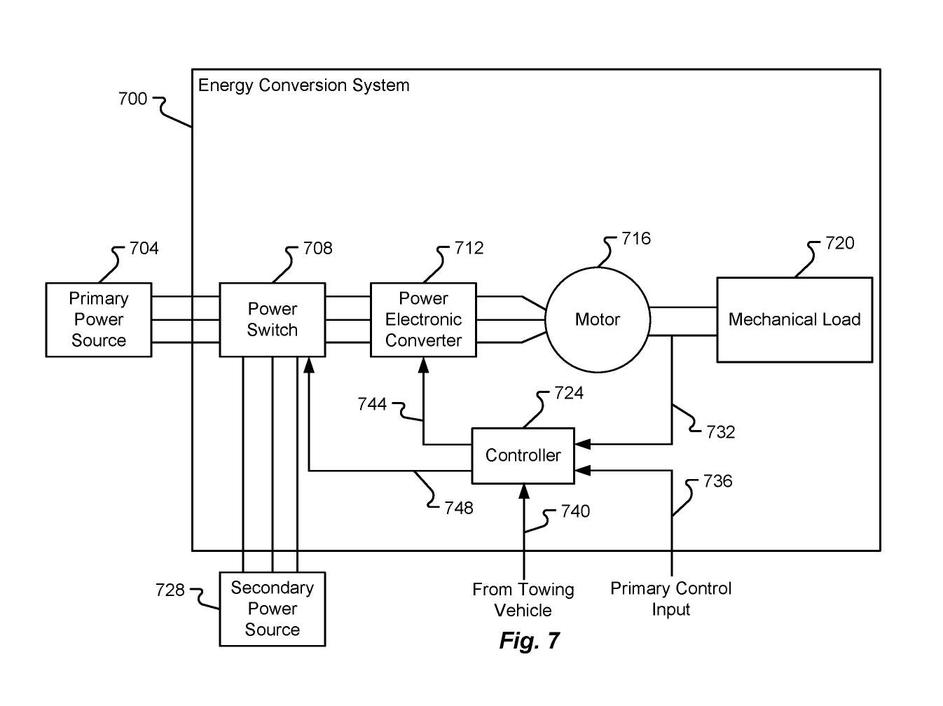

The electric motor 804 can be any type of DC or AC electric motor. The electric motor may be a direct drive or induction motor using permanent magnets and/or winding either on the stator and/or rotor. The electric motor 804 may also be wireless or include brush contacts. The electric motor 804 may be capable of providing a torque and enough kinetic energy to move the vehicle 100 in traffic. In some embodiments, the electric motor 804 may be similar, if not identical, to the electric motor 212 described in conjunction with FIG. 2 and/or the motor 716 described in conjunction with FIG. 7. As will be discussed in further detail herein, the motor 804 (and other examples of motors described herein), can be utilized to transmit one or more messages. In other words, the motor 804 may be dual-purposed to help provide physical motion to the vehicle 100 as well as provide communication capabilities.

The different loads 508 may also include environmental loads 812, sensor loads 816, safety loads 820, user interaction loads 808, etc. User interaction loads 808 can be any energy used by user interfaces or systems that interact with the driver and/or passenger(s) of the vehicle 100. These loads 808 may include, for example, the heads up display 434, the dash display 420, 424, 428, the radio, user interfaces on the head unit, lights, radio, and/or other types of loads that provide or receive information from the occupants of the vehicle 100. The environmental loads 812 can be any loads used to control the environment within the vehicle 100. For example, the air conditioning or heating unit of the vehicle 100 can be environmental loads 812. Other environmental loads can include lights, fans, and/or defrosting units, etc. that may control the environment within, and/or outside of, the vehicle 100. The sensor loads 816 can be any loads used by sensors, for example, air bag sensors, GPS, and other such sensors used to either manage or control the vehicle 100 and/or provide information or feedback to the vehicle occupants. The safety loads 820 can include any safety equipment, for example, seat belt alarms, airbags, headlights, blinkers, etc. that may be used to manage the safety of the occupants of the vehicle 100. There may be more or fewer loads than those described herein, although they may not be shown in FIG. 8.

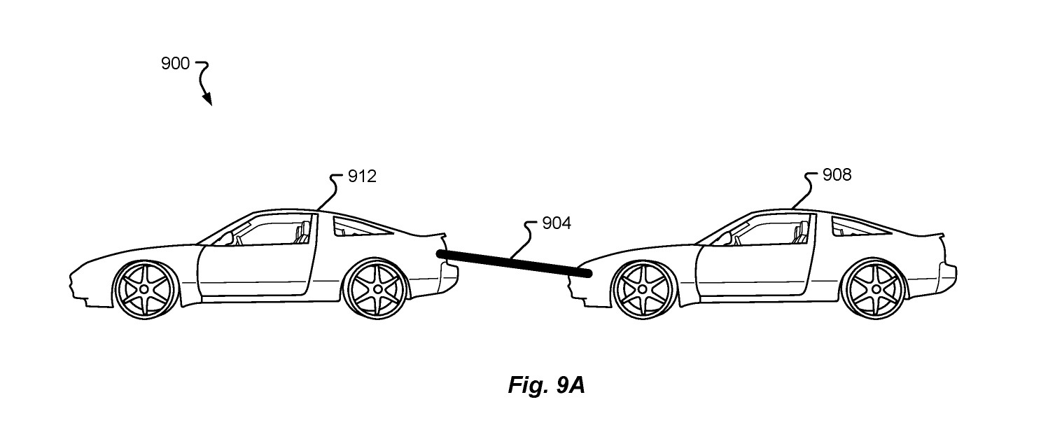

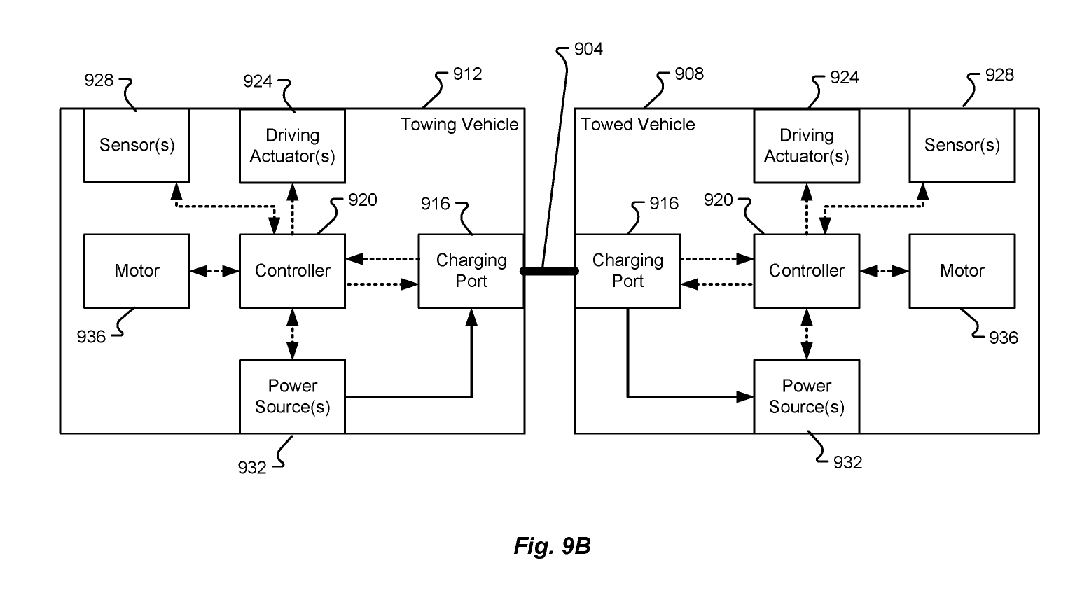

With reference now to FIGS. 9A and 9B, additional details of a towing scenario 900 will be described in accordance with at least some embodiments of the present disclosure. The towing scenario 900 shows a towing vehicle 912 connected with a towed vehicle 908 via a towing cable 904. As will be discussed in further detail herein, the towing cable 904 is not necessarily required to transmit a mechanical force from the towing vehicle 912 to the towed vehicle 908. Rather, the towing cable 904 is used to electrically connect the vehicles 908, 912 to one another such that the towing vehicle 912 is allowed to provide power to the towed vehicle 908 as well as control operations of the towed vehicle 908 while the two are connected. Accordingly, the towing cable 704 does not necessarily have to be designed to transmit mechanical energy between the vehicles like a traditional tow rope or chain. The towing cable 904 is provided with the ability to carry power and control signals so that a mechanical force doesn't have to be transmitted between the vehicles. As a base set of functions, the towing cable 904 may have functionality and/or structure similar or identical to one or more of the SAE J1772 connector, CHAdeMo, DC fast charger, DC CCS Combo, IEC 62196, to name a few. However, the towing cable 904 also carries a larger amount of data in the form of control signaling and sensor information between the vehicles.

Furthermore, although FIG. 9A schematically shows a car towing a similar type of car, it should be appreciated that the towing vehicle 912 and towed vehicle 908 do not have to be of the same type. While it is possible to have one car tow another car (e.g., because there is not requirement to rely on the transfer or mechanical forces), embodiments of the present disclosure contemplate that a truck may tow a car, a car may tow a truck, or any size vehicle is allowed to tow another vehicle of equal, greater, or smaller size.

FIG. 9B shows the components of the towing vehicle 912 and towed vehicle 908 that facilitate a towing scenario. Specifically, both vehicles 908, 912 are shown to include a charging port 916, a controller 920, driving actuator(s) 924, sensor(s) 928, power source(s) 932, and a motor 936. It should be appreciated that the components of the towed vehicle 908 do not necessarily have to be the same as the components of the towing vehicle 912. Furthermore, the characteristics of similar components do not necessarily have to behave in the same way or be identical. It may be desirable, however, to have charging ports 916 that are similar in structure and capabilities so that different variations of a towing cable 904 are not required; however, it should be appreciated that if the charging ports 916 of the vehicles 908, 912 are not identically the same, then one or more converters or adaptors may be provided between the towing cable 904 and a charging port 916.

The charging port 916 of a vehicle may correspond to an electromechanical interface for the power supply system and the control system of the vehicle. In some embodiments, the towing cable 904 is designed to carry both power (e.g., three-phase power) as well as data (e.g., control signaling and sensor information). Accordingly, the charging port 916 is designed to include both a power interface as well as a data interface. The power interface of the charging port 916 may enable power to be provided from a power source 932 of the towing vehicle 912 to a power source 932 of the towed vehicle 908 (e.g., to help begin charging the power source 932 of the towed vehicle). This flow of power is shown via the solid lines of FIG. 9B. Although not depicted, power may alternatively or additionally be provided from the charging port 916 of the towed vehicle 908 directly to the motor 936 of the towed vehicle 908. As discussed in connection with FIG. 7, in such a scenario the power source 932 of the towing vehicle 912 may correspond to a secondary power source 728 and the controller 724 of the towed vehicle's 908 energy conversion system 700 may cause the motor 716 to be powered by the secondary power source 728 rather than the primary power source 704 (e.g., the power source 932 of the towed vehicle 908). This additional path of power may enable the towed vehicle 908 to operate with its own motor 936 and driving actuators 924 rather than simply being pulled by the towing vehicle 912.

The data communicated between the vehicles 908, 912 (as indicated by dotted lines) may include sensor data flowing from the towed vehicle 908 to the towing vehicle 912, control signaling flowing from the towing vehicle 912 to the towed vehicle 908, and any other type of data useful in connection with a towing scenario. For instance, a status of charge for the power source 932 of the towed vehicle 908 may also be communicated to the towing vehicle 912 to enable the towing vehicle 912 to determine whether towing/charging are still required or not.

The power source(s) 932 may be similar or identical to any of the power sources described herein. Similarly, the motors 936 may be similar or identical to any of the motors described herein.

The controller 920 may have similar functionalities to other controllers described herein. For instance, the controller 920 may have power control functionality similar to controller 724. The controller 920, however, is also contemplated to serve as the primary navigational and/or steering control center for the vehicle. Accordingly, the controller 920 may receive sensor information from a number of sensors 928 of various sensor types such as navigational sensors, image sensors, audio sensors, magnetic sensors, accelerometers, voltage sensors, current sensors, temperatures sensors, etc. The controller 920 may also provide an interface between the user's control panel 400, pedals (brake and acceleration), steering wheel, etc. (which may also have sensors) and the driving actuators 924. Examples of actuators 924 include, without limitation, steering actuators, acceleration actuators (e.g., if different from the motor 936), braking actuators, turn signals actuators, brake lights, headlights, etc. It should be appreciated that the controller 920 may correspond to a single microcontroller or a plurality of microcontrollers in communication with one another. Thus, the controller 920 may actually correspond to a system of controllers that are used to assert control (whether autonomous driving control or manual driving control) over the vehicle. As shown, there may be a flow of data between the power source 932 and the controller 920 to help determine a state of charge of the power source 932 and other pertinent information.

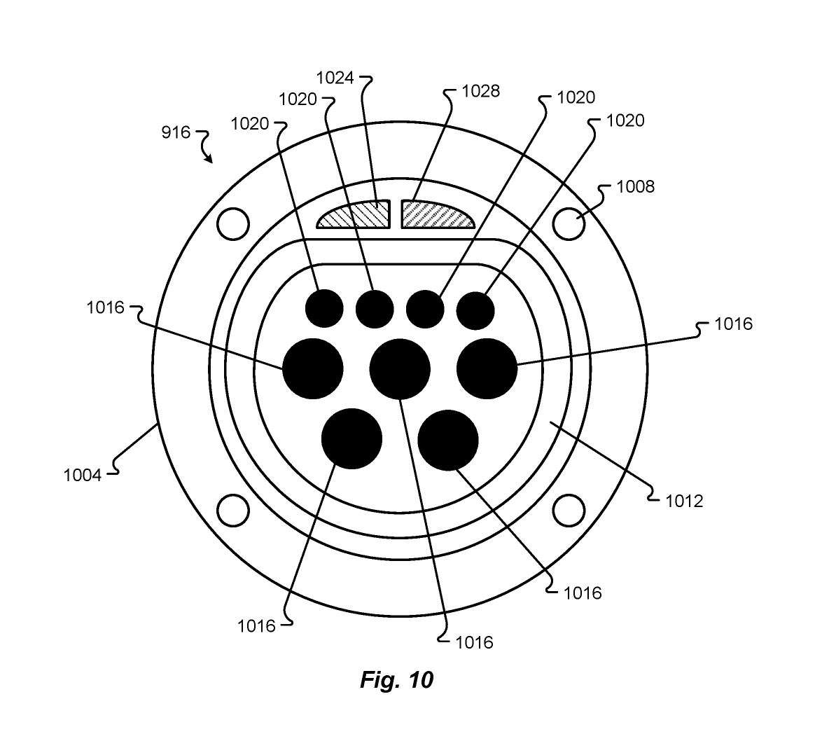

As can be appreciated, the charging port 916 may include both mechanical components that enable a mechanical connection between the towing cable 904 and the vehicle 908, 912 as well as electrical components that enable an electrical connection between the towing cable 904 and components within the vehicle 908, 912. FIG. 10 depicts an illustrative structure of a charging port 916 that may be used in accordance with embodiments of the present disclosure. The charging port 916 is shown to include a flange 1004 with a plurality of mounting holes 1008. The flange 1004 and mounting holes 1008 may facilitate a mechanical connection between the charging port 916 and the chassis of the vehicle.

The charging port 916 is also shown to include a receptacle 1012 and a plurality of electrical interfaces 1016, 1020. The receptacle 1012 may include a complimentary shape to receive a connecting end of the towing cable 904 (or other charging cable). The receptacle 1012 may correspond to a raised portion of material, a recessed portion of material, or any other physical configuration that enables a mating between the physical aspects of the charging port 916 and the towing cable 904.

The electrical interfaces 1016, 1020 may include mechanical and electrical components that carry a current to/from the towing cable 904 that travels to or from a power source of the vehicle. In some embodiments, a first set of electrical interfaces 1016 are used to carry current to or from a power source of a vehicle. As such, the first set of electrical interfaces 1016 may be designed to carry three-phase power and may be attached to cabling or connectors that are designed to accommodate relatively large currents and/or voltages. A second set of electrical interfaces 1020 are used to carry data to or from the controller of a vehicle. In some embodiments, the second set of electrical interfaces 1020 are configured to carry a smaller current than the first set of electrical interfaces 1016. As a non-limiting example, the second set of electrical interfaces 1020 may carry analog or digital signals that include sensor information flowing from one vehicle to another as well as control signaling that flows from one vehicle to another. The sensor information may be adapted to flow in some of the second set of electrical interfaces 1020 whereas the control signaling may flow on others of the second set of electrical interfaces 1020. In some embodiments, the control signaling and sensor information may be sent in packets, as basic digital signals, as modulated signals, as multiplexed signals, or in any other fashion known in the communication arts.

The charging port 916 is also shown to include a first indicator 1024 and a second indicator 1028. Traditionally, the indicators of a charging port were used to indicate whether a charging connection was established between a charging station and the power source of the vehicle. In accordance with embodiments of the present disclosure, one or both of the indicators 1024, 1028 may be used to indicate whether a proper connection is made between the towing cable 904 and the vehicle and also to indicate whether data is properly flowing from one vehicle to the other vehicle. Said another way, one of the indicators 1024, 1028 may provide a visual, audible, tactile, or other type of indication to a user that a data path has been established between a towing vehicle 912 and a towed vehicle 908. Such an indicator can be used to ensure that both vehicles are properly connected before initiating a towing scenario.

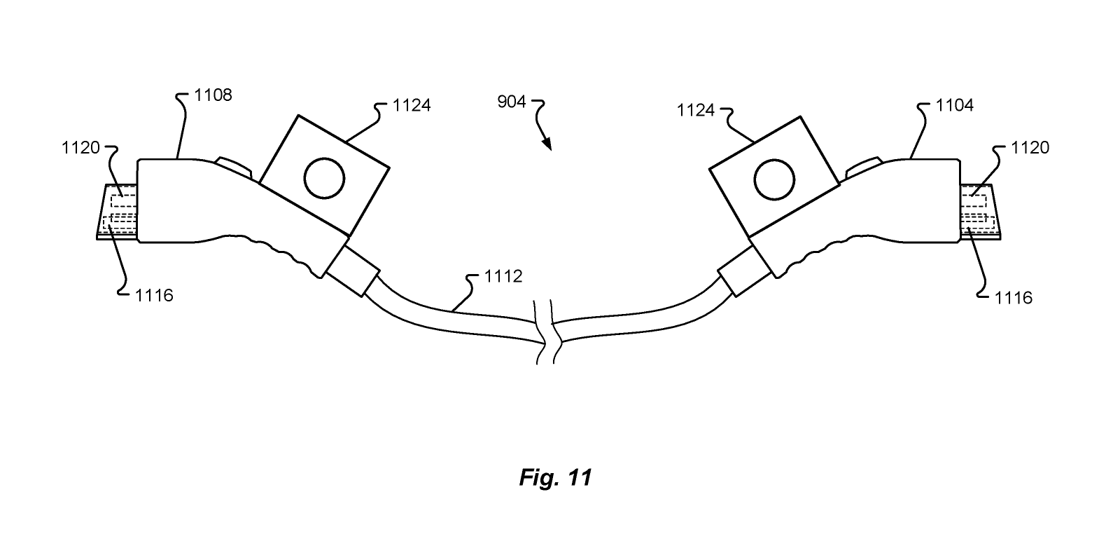

FIG. 11 depicts additional details of a towing cable 904 in accordance with at least some embodiments of the present disclosure. The towing cable 904 is shown to include a first end 1104, a second end 1108, and a cable 1112 therebetween. In some embodiments, the cable 1112 may include a plurality of independently insulated conductors that carry either power or data between the ends 1104, 1108. Each end 1104, 1108 may comprise a number of plugs, pins, or adaptors 1116, 1120 that fit or cooperate with the electrical interfaces 1016, 1020 of the charging port 916. In some embodiments, the plugs may include a first set of plugs 1116 and a second set of plugs 1120 that interface with the first set of electrical interfaces 1016 and second set of electrical interfaces 1020, respectively. Thus, the first set of plugs 1116 may be used to carry power whereas the second set of plugs 1020 may carry data. While the term plugs is used herein with respect to the towing cable 904, it should be appreciated that the towing cable may include female mating components of the interface whereas the charging port 916 may include the male mating components of the interface. Thus, the embodiment of FIG. 11 showing that the towing cable 904 includes the male connectors should not be construed as limiting the claims in any way.

The towing cable 904 is also shown to include a retractor housing 1124. As will be discussed in further detail herein, the towing cable 904 may include structurally rigid connecting components and/or structurally flexible connecting components. In some embodiments, the towing cable 904 may even be designed to operate in a rigid manner as well as a flexible manner. For instance, where an autonomously-driven vehicle is designed to tow another autonomously-driven vehicle, there may be instances where a user is unavailable to physically grasp the ends 1104, 1108 of the charging cable 904 and insert them into the charging port 916. In such circumstances, the towing cable 904 may initially take a rigid form to facilitate an automated connection between the vehicles. Once connected, however, the rigidity of the towing cable 904 may be relaxed or changed to allow some degree of flexibility. This flexibility may be desirable during active towing since it may be difficult or impossible to have both vehicles connected together with a rigid member. In some embodiments, excess flexible cabling may be automatically retracted and stored in the retractor housing 1124. By having this housing 1124 on one or both ends of the towing cable 904, there is an ability to flexibly connect the towing vehicle 912 with the towed vehicle 908 without allowing excess cable 1112 to drag between the vehicles. It should be appreciated that any type of retraction mechanism (e.g., spring-loaded wheels, pinchers, etc.) may be used to ensure that an adequate amount of cable 1112 is released and free between the ends 1104, 1108 without releasing too much cable 1112.

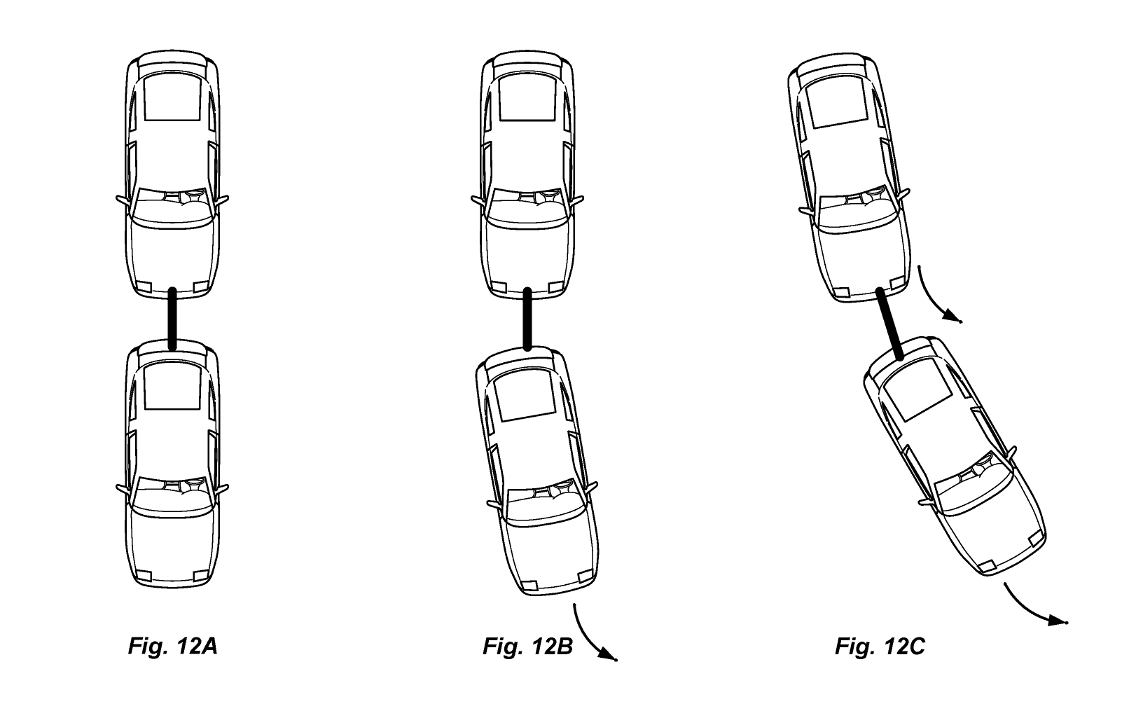

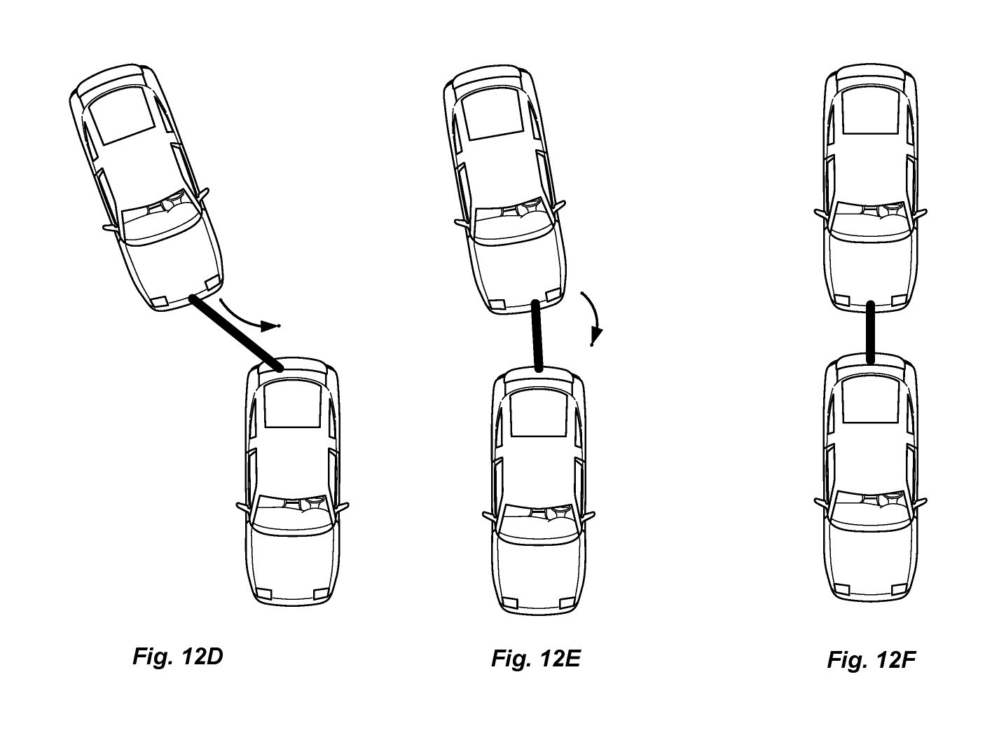

As shown in FIGS. 12A-F, while the towing vehicle 912 is towing the towed vehicle 908, there may be situations where the distance and angle between the vehicles 908, 912 changes. The towed vehicle 908 may be controlled in such a way that these changes in distance and/or angle may be minimized. For instance, the acceleration, deceleration, and directional movements of the towed vehicle 908 may be adjusted in coordination with the acceleration, deceleration, and directional movements of the towing vehicle 912, with only a slight delay between the two. As shown in FIGS. 12A and 12F, if the towing vehicle 912 is traveling in a straight line, then the towed vehicle 908 may also travel in that straight line substantially behind the towing vehicle 912 while maintaining a predetermined distance therebetween. As shown in FIGS. 12B-E, however, as the towing vehicle 912 begins to turn or change lanes (FIG. 12B), the towed vehicle 908 may initially maintain its straight path. This may only continue for a brief moment (e.g., less than 2 seconds) for purposes of avoiding overcorrections to minor movements made by the towing vehicle 912. However, after a predetermined amount of time has passed and the towing vehicle 912 continues to depart from the path of the towed vehicle 908, the towed vehicle 908 may begin to follow the directional movement of the towing vehicle 912 (this may include adjusting both the direction of travel of the towed vehicle 908 and/or accelerating the towed vehicle 908 slightly to minimize the change in the distance between the vehicles). The towing vehicle 912 may continue to follow a turning path or changing lanes (FIG. 12C) until no further turns are desired for the towing vehicle 912 (FIG. 12D). The towed vehicle 908 may continue to require adjustments in both directional travel and acceleration/deceleration (FIG. 12E) until it is positioned directly behind the towing vehicle 912 and both vehicles are on a common path of travel again.

It should be appreciated that the control signals provided to the towed vehicle 908 may correlate to control signals used for driving the towing vehicle 912. As such, while in a towing mode, the towing vehicle 912 may treat its boundaries as corresponding to both vehicles (e.g., the towed and towing vehicles) rather than just corresponding to its own boundaries. Thus, the towing vehicle 912 may navigate itself as a combination of both vehicles by ensuring both vehicles avoid obstacles, hazards, other vehicles, etc.

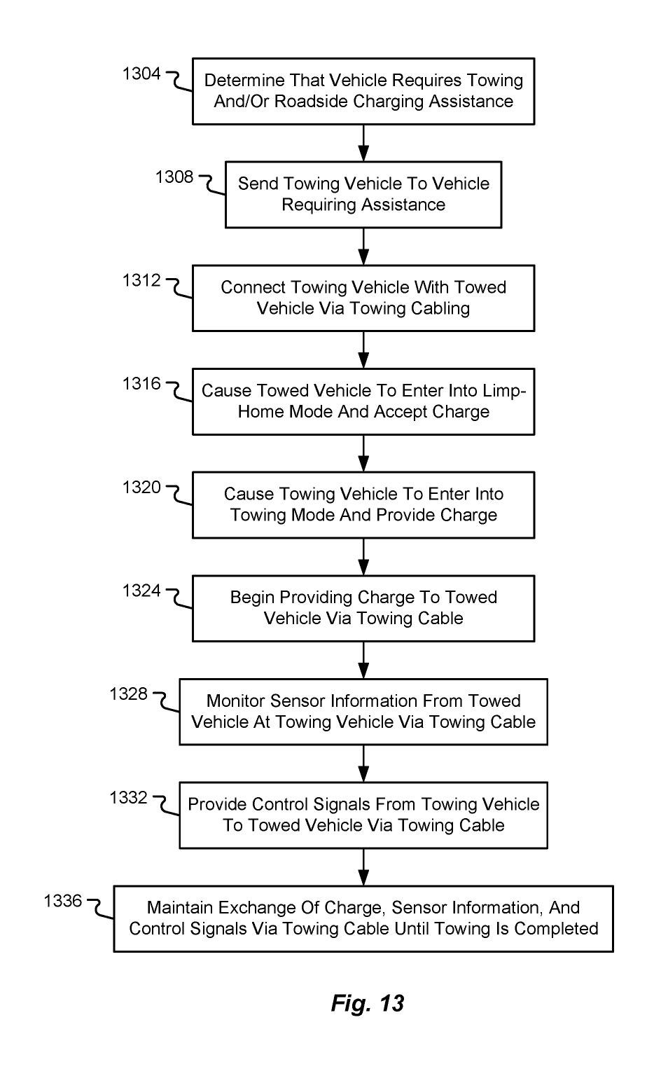

With reference now to FIG. 13, additional details of a towing method will be described in accordance with at least some embodiments of the present disclosure. The method begins by determining that a vehicle requires towing and/or roadside assistance (step 1304). This may be determined in response to receiving a distress signal from the vehicle or by noticing that the vehicle is stopped along the side of a road.

In response to determining that the vehicle requires assistance, a towing vehicle 912 is sent to the vehicle in distress (step 1308). The towing vehicle 912 is then connected to the vehicle in distress via the towing cable 904 (step 1312). Once the two vehicles are connected with one another, the method continues by causing the towed vehicle 908 to enter into a limp-home mode of operation (step 1316) and causing the towing vehicle 912 to enter into a towing mode (step 1320). When the towing vehicle 912 and towed vehicle 908 enter these respective modes of operation, the towing vehicle 912 begins to provide charge/power/current to the towed vehicle 908 via the towing cable 904 (step 1324). The charge/power/current may be provided in the form of three-phase AC power, single-phase AC power, DC power, or the like. Upon receiving the power from the towing vehicle 912, the towed vehicle 908 may provide some of the power to begin recharging its own power source(s). The towed vehicle 908 may also provide some of the power to its electrical components and/or motor to enable operation of the towed vehicle 908 during towing operations.

While towing, the towed vehicle 908 may provide sensor information to the towing vehicle 912 via the towing cable 904 (step 1328). For instance, the towed vehicle 908 may provide sensor information regarding one or more of its image sensors, proximity sensors, temperature sensors, accelerometers, tire pressure sensors, or the like. The sensor information may help inform the towing vehicle 912 with respect to the environment about the towed vehicle 908. The towing vehicle 912 may also provide the towed vehicle 908 with control signals via the towing cable 904 (step 1332). The control signals may include signals that cause the towed vehicle 908 to turn, accelerate, decelerate, and so on. The control signals provided to the towed vehicle 908 may be implemented by actuators of the towed vehicle 908 such that the towed vehicle maintains a substantially constant position relative to the towing vehicle 912 (e.g., a predetermined distance away from the towing vehicle 912 and within a defined angle behind the towing vehicle 912).

The exchange of charge, sensor information, and control signals may continue to travel across the towing cable 904 until the towing is completed (step 1336). Thereafter, the towing cable 904 may be disconnected from both vehicles and each vehicle may be allowed to independently drive itself.

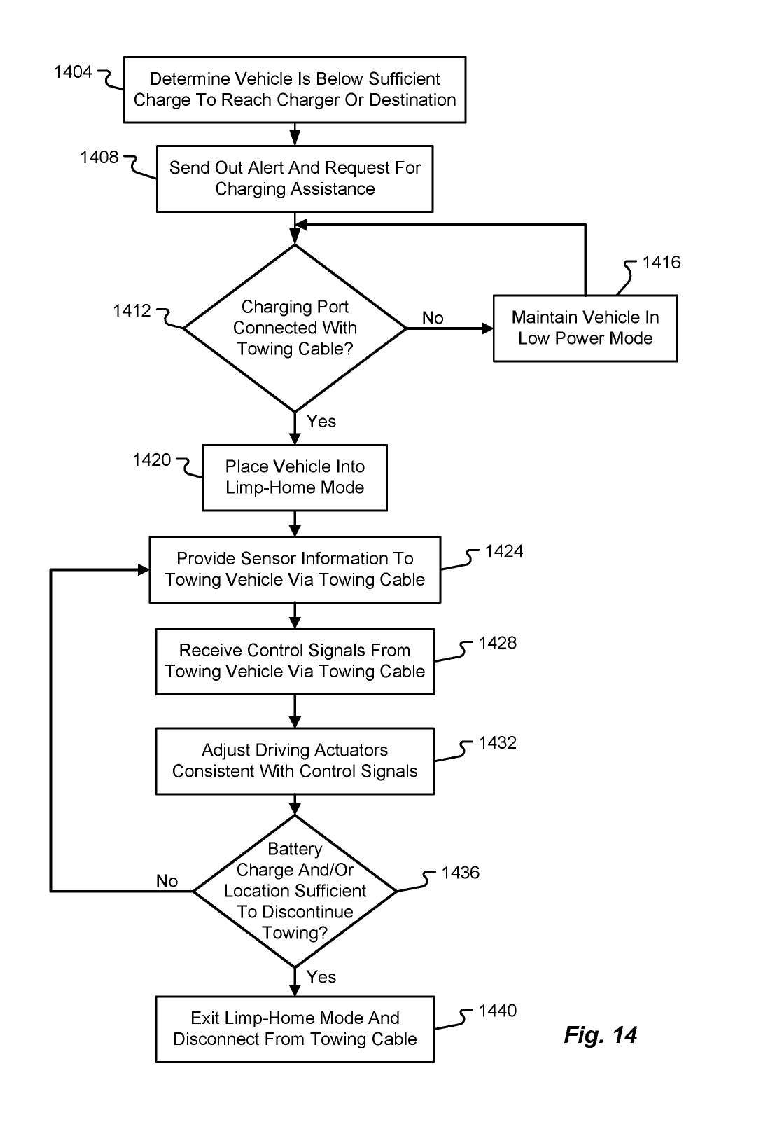

With reference now to FIG. 14, additional details of a towing method from the perspective of a towed vehicle 908 will be described in accordance with at least some embodiments of the present disclosure. The method begins when the vehicle determines that its power source is below a sufficient charge to reach a nearest charging station and/or final destination (step 1404). In response to making this determination, the vehicle may send out an alert or distress signal that effectively acts as a request for charging assistance from another vehicle (step 1408). The vehicle may be moved to the side of the road until such time as an assisting vehicle arrives. The vehicle may have sent out the distress signal prior to completely losing charge from its power source(s). Accordingly, certain primitive and/or basic functions of the vehicle may remain operational even though the vehicle is not going to drive further. Thus, the vehicle may monitor its charging port to determine if it has been connected with a towing cable (step 1412). Until a towing cable 904 is detected, the vehicle may remain in a low power mode where only basic functions are operational (step 1416). Detection of a towing cable 904 may be different from detection of a basic charging cord. Specifically, a towing cable 904 may be detected in response to identifying that both charge/power and data are flowing into the charging port. If only charge/power are detected, then it may not be determined that a towing cable 904 has been connected with the vehicle.

Once a towing cable 904 is detected at the charging port (e.g., both charge/power and data connections are detected), the method continues by placing the vehicle into a limp-home mode (step 1420). This mode of operation may cause the towed vehicle to hand over control functionality/decisions to the towing vehicle. Alternatively or additionally, the limp-home mode may cause the towed vehicle 908 to begin providing sensor information to the towing vehicle 912 via the towing cable 904. Alternatively or additionally, the limp-home mode may cause the towed vehicle 908 to remain in a low power mode.

Accordingly, when the towed vehicle 908 is placed in the limp-home mode, the towed vehicle 908 will provide sensor information to the towing vehicle, thereby enabling the towing vehicle 912 to have an awareness of the environment surrounding the towed vehicle 908 (step 1424). The towed vehicle 908 may also receive control signals from the towing vehicle 912 (step 1428) and respond to the control signals in an appropriate manner (step 1432). This flow of charge, sensor information, and control signals may continue throughout the towing operations. The method will continue until it is determined that the battery charge and/or location of the towed vehicle 908 is sufficient to discontinue towing (step 1436). This decision may be made by the towed vehicle 908, the towing vehicle 912, or a combination of the two. Once the query of step 1436 is answered affirmatively, the method continues by taking the towed vehicle 908 out of the limp-home mode and disconnecting the towing cable 904 from the towed vehicle 908 (step 1440). In some embodiments, when the towing cable 904 is disconnected, then the previously-towed vehicle may retain control of its own driving actuators, respond to its driver inputs (whether autonomous or manual), and utilize its own power source to power the motor and other components of the vehicle.

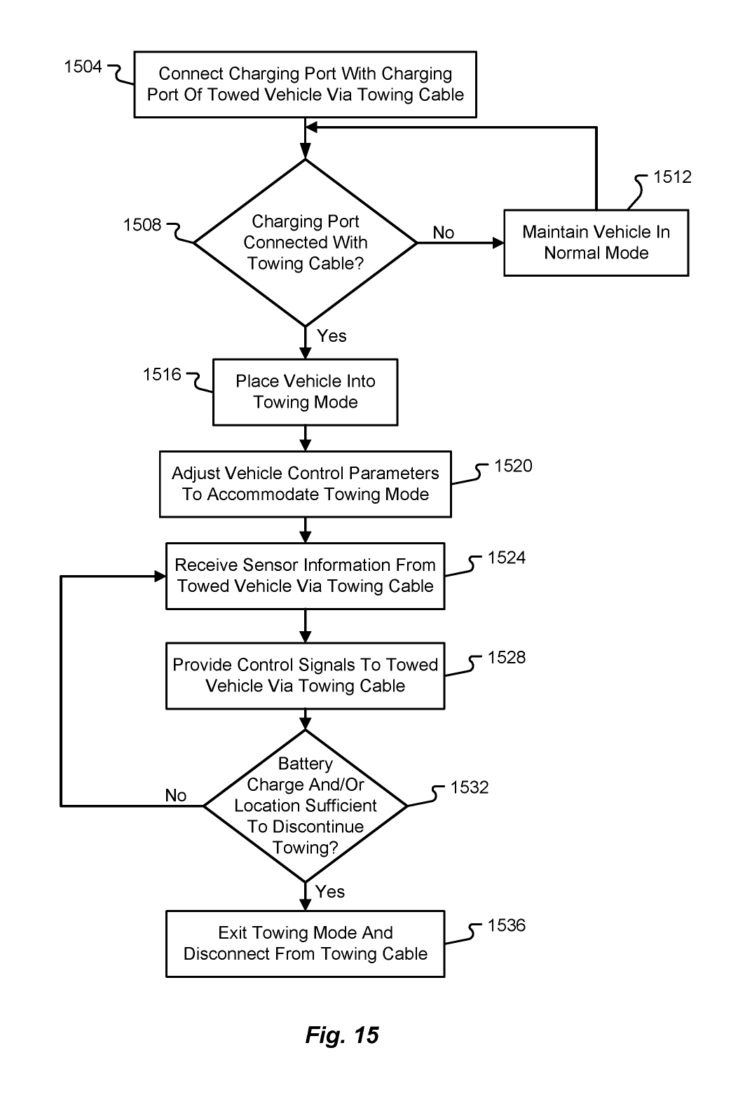

With reference now to FIG. 15, additional details of a towing method from the perspective of a towing vehicle 912 will be described in accordance with at least some embodiments of the present disclosure. The method begins by connecting the charging port of the towing vehicle 912 with the charging port of the towed vehicle 908 via the towing cable 904 (step 1504). Until such time as a vehicle-to-vehicle connection is established with the towing cable 904 (e.g., facilitating the exchange of data and power), the towing vehicle will remain in a normal mode of operation (steps 1508, 1512). Once it is determined that the charging ports of the vehicles have been properly connected and data as well as power is flowing between the vehicles, the method continues by placing the towing vehicle 912 into a towing mode of operation (step 1516). In this mode of operation, the towing vehicle 912 may have to adjust its control parameters (especially if operating in an autonomous driving mode) to accommodate the towing mode (step 1520). Specifically, the towing vehicle 912 may have to adjust its controller to look for and accept sensor information from the towed vehicle 908. The towing vehicle 912 may also have to accommodate for the sensor information received from the towed vehicle 908 such that both vehicles 908, 912 are driven and controlled so as to both avoid obstacles and road hazards.

While in towing mode, the towing vehicle 912 may receive sensor information from the towed vehicle 908 (step 1524). Likewise, the towing vehicle 912 may provide control signals to the towed vehicle 908 (step 1528). This will continue until it is determined that towing can be discontinued (step 1532). This determination to discontinue towing may be made based on battery charge, location, or other factors. Once the determination is made to discontinue towing, the towing cable 904 is disconnected from one or both of the charging ports of the vehicles and the towing vehicle 912 is allowed to exit towing mode and return to the normal mode of operation (step 1536).

The exemplary systems and methods of this disclosure have been described in relation to vehicle systems and electric vehicles. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

Embodiments include a vehicle. One non-limiting example of the vehicle includes a charging port that facilitates connection with a towing cable; a power source that is configured to receive power from the charging port or provide power to the charging port when the towing cable is connected with the charging port; and a controller in electrical communication with the charging port, wherein the controller is configured to receive and/or provide data to the charging port to facilitate vehicle-to-vehicle communications via the towing cable.

An aspect of the above-described vehicle contemplates that the controller provides data to the charging port in the form of control signaling when the power source is providing power to the charging port. In some embodiments, control signaling is communicated to a towed vehicle via the towing cable and the control signaling causes the towed vehicle to adjust at least one of a direction of travel, speed, acceleration, or deceleration in response to the control signaling.

Another aspect of the vehicle contemplates that the controller provides data to the charging port in the form of sensor information when the power source is receiving power from the charging port. In some embodiments, the sensor information is communicated to a towing vehicle via the towing cable and the sensor information corresponds to information obtained from one or more sensors of the vehicle and is used by the towing vehicle in connection with making control decisions for the vehicle. In some embodiments, the towing cable does not transfer substantial mechanical forces from the towing vehicle to the vehicle.

Another aspect of the vehicle contemplates that the data is communicated via the towing cable via one or more digital signals.

Another aspect of the vehicle contemplates that the power is provided as at least one of three-phase AC power, single-phase AC power, and DC power. In some embodiments, the data includes both control signaling and sensor information and the power, control signaling, and sensor information are each communicated over different conductors of the towing cable.

Any one or more of the aspects/embodiments as substantially disclosed herein.

Any one or more of the aspects/embodiments as substantially disclosed herein optionally in combination with any one or more other aspects/embodiments as substantially disclosed herein.

One or means adapted to perform any one or more of the above aspects/embodiments as substantially disclosed herein.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “electric vehicle” (EV), also referred to herein as an electric drive vehicle, may use one or more electric motors or traction motors for propulsion. An electric vehicle may be powered through a collector system by electricity from off-vehicle sources, or may be self-contained with a battery or generator to convert fuel to electricity. An electric vehicle generally includes a rechargeable electricity storage system (RESS) (also called Full Electric Vehicles (FEV)). Power storage methods may include: chemical energy stored on the vehicle in on-board batteries (e.g., battery electric vehicle or BEV), on board kinetic energy storage (e.g., flywheels), and/or static energy (e.g., by on-board double-layer capacitors). Batteries, electric double-layer capacitors, and flywheel energy storage may be forms of rechargeable on-board electrical storage.

The term “hybrid electric vehicle” refers to a vehicle that may combine a conventional (usually fossil fuel-powered) powertrain with some form of electric propulsion. Most hybrid electric vehicles combine a conventional internal combustion engine (ICE) propulsion system with an electric propulsion system (hybrid vehicle drivetrain). In parallel hybrids, the ICE and the electric motor are both connected to the mechanical transmission and can simultaneously transmit power to drive the wheels, usually through a conventional transmission. In series hybrids, only the electric motor drives the drivetrain, and a smaller ICE works as a generator to power the electric motor or to recharge the batteries. Power-split hybrids combine series and parallel characteristics. A full hybrid, sometimes also called a strong hybrid, is a vehicle that can run on just the engine, just the batteries, or a combination of both. A mid hybrid is a vehicle that cannot be driven solely on its electric motor, because the electric motor does not have enough power to propel the vehicle on its own.

The term “rechargeable electric vehicle” or “REV” refers to a vehicle with on board rechargeable energy storage, including electric vehicles and hybrid electric vehicles.

What is claimed is:

1. A vehicle, comprising:
a charging port that facilitates connection with a towing cable;
a power source that is configured to receive power from the charging port or provide power to the charging port when the towing cable is connected with the charging port; and
a controller in electrical communication with the charging port, wherein the controller is configured to receive and/or provide data to the charging port to facilitate vehicle-to-vehicle communications via the towing cable.

2. The vehicle of claim 1, wherein the controller provides data to the charging port in the form of control signaling when the power source is providing power to the charging port.

3. The vehicle of claim 2, wherein the control signaling is communicated to a towed vehicle via the towing cable and wherein the control signaling causes the towed vehicle to adjust at least one of a direction of travel, speed, acceleration, or deceleration in response to the control signaling.

4. The vehicle of claim 1, wherein the controller provides data to the charging port in the form of sensor information when the power source is receiving power from the charging port.

5. The vehicle of claim 4, wherein the sensor information is communicated to a towing vehicle via the towing cable and wherein the sensor information corresponds to information obtained from one or more sensors of the vehicle and is used by the towing vehicle in connection with making control decisions for the vehicle.

6. The vehicle of claim 5, wherein the towing cable does not transfer substantial mechanical forces from the towing vehicle to the vehicle.

7. The vehicle of claim 1, wherein the data is communicated via the towing cable via one or more digital signals.

8. The vehicle of claim 1, wherein the power is provided as at least one of three-phase AC power, single-phase AC power, and DC power.

9. The vehicle of claim 8, wherein the data includes both control signaling and sensor information and wherein the power, control signaling, and sensor information are each communicated over different conductors of the towing cable.

10. A towing vehicle configured to tow a towed vehicle, the towing vehicle comprising:
a charging port that facilitates connection with a towing cable;
a power source that is configured to provide power to the charging port when the towing cable is connected with the charging port and when the towing cable is also connected with the towed vehicle; and
a controller in electrical communication with the charging port, wherein the controller is configured to receive and/or provide data to the charging port to facilitate vehicle-to-vehicle communications via the towing cable.

11. The towing vehicle of claim 10, wherein the controller provides data to the towed vehicle in the form of control signaling and wherein the controller receives data from the towed vehicle in the form of sensor information.

12. The towing vehicle of claim 11, wherein the charging port comprises separate interfaces for communicating the power, control signaling, and sensor information.

13. The towing vehicle of claim 11, wherein the controller is configured to operate in a towing mode while the towing cable is connected to both the towing vehicle and towed vehicle and wherein the towing mode causes the controller to consider the sensor information received from the towed vehicle in connection with producing the control signaling for the towed vehicle as well as producing control signaling for the towing vehicle.

14. The towing vehicle of claim 10, wherein the charging port comprises one or more indicators that identify when both power and data are being exchanged via the towing cable.

15. A towed vehicle configured to be towed by a towing vehicle, the towed vehicle comprising:
a charging port that facilitates connection with a towing cable;
a power source that is configured to receive power from the charging port when the towing cable is connected with the charging port and when the towing cable is also connected with the towing vehicle; and
a controller in electrical communication with the charging port, wherein the controller is configured to receive and/or provide data to the charging port to facilitate vehicle-to-vehicle communications via the towing cable.

16. The towed vehicle of claim 15, wherein the controller provides data to the towing vehicle in the form of sensor information obtained from one or more sensors of the towed vehicle and wherein the controller receives data from the towed vehicle in the form of control signaling.

17. The towed vehicle of claim 16, wherein the charging port comprises separate interfaces for communicating the power, control signaling, and sensor information.

18. The towed vehicle of claim 16, wherein the controller is configured to operate in a limp-home mode while the towing cable is connected to both the towing vehicle and towed vehicle and wherein the limp-home mode causes the controller to adjust one or more actuators of the towing vehicle in accordance with the control signaling received from the towing vehicle.

19. The towed vehicle of claim 15, wherein the charging port comprises one or more indicators that identify when both power and data are being exchanged via the towing cable.

20. The towed vehicle of claim 15, wherein the power is provided as at least one of three-phase AC power, single-phase AC power, and DC power.
